(19) United States
(12) Patent Application Publication
(10) Pub. No.: US 2017/0164020 A1
(43) Pub. Date: Jun. 8, 2017

(54) CONTENT DELIVERY METHOD FOR CONTENT DELIVERY NETWORK PLATFORM AND SCHEDULING PROXY SERVER

(71) Applicants: LE HOLDINGS (BEIJING) CO., LTD., Beijing (CN); LECLOUD COMPUTING CO., LTD., Beijing (CN)

(72) Inventor: Hongfu LI, Beijing (CN)

(21) Appl. No.: 15/246,143

(22) Filed: Aug. 24, 2016

Related U.S. Application Data
(63) Continuation of application No. PCT/CN2016/088809, filed on Jul. 6, 2016.

(30) Foreign Application Priority Data
Dec. 8, 2015 (CN) 201510896611.3

(51) Int. Cl. H04N 21/231; H04N 21/2183; H04N 21/234; H04N 21/262; H04N 21/81; H04N 21/222; H04N 21/232

(52) U.S. Cl. CPC H04N 21/23106; H04N 21/222; H04N 21/2183; H04N 21/2326; H04N 21/26241; H04N 21/812; H04N 21/23424

(57) ABSTRACT

The present disclosure provides a content delivery method, a scheduling proxy server and a non-transitory computer-readable medium for a content delivery network (CDN) platform. The method includes sending by a scheduling proxy server a received access request of a user to a scheduling center, and receiving a video service node address which is capable of responding to the access request and determined by the scheduling center based on the access request of the user, downloading and caching by the scheduling proxy server video files from the video service node address determined by the scheduling center, splicing by the scheduling proxy server the cached video files into a complete media file, and responding to the access request of the user by the scheduling proxy server using the cached complete media file.

### CROSS REFERENCE TO RELATED APPLICATIONS

This application is a continuation of International Application No. PCT/CN2016/088809, filed on Jul. 6, 2016, which is based upon and claims priority to Chinese Patent Application No. 201510896611.3, filed on Dec. 8, 2015, the entire contents of both of which are incorporated herein by reference.

### TECHNICAL FIELD

Embodiments of the present disclosure relate to the technical field of internet media, and more particularly to a content distributing method for a content delivery network (CDN) platform and a scheduling proxy server.

### BACKGROUND

A content delivery network (CDN) is a layer of intelligent virtual network formed by disposing node servers at each part of a network based on an existing internet. The CDN can re-direct in real time a request of a user to a service node closest to the user according to comprehensive information, such as a network traffic condition, connection conditions of the nodes, load conditions, a distance to the user and response time. The CDN aims to send required content to the user by selecting the node relatively closer to the user, such that a congestion condition of the network is relieved, and a response speed of a website is improved.

### SUMMARY

In order to reduce the times of communication between the user and a plurality of nodes and solve the problem of unsmooth and instable playing of the video caused by network response delay, the present disclosure provides a content delivery method for a CDN platform, a scheduling proxy server and a non-transitory computer-readable medium.

The present disclosure provides a content delivery method for a CDN platform. The method may include: sending a received access request of a user to a scheduling center by a scheduling proxy server, and receiving a video service node address which is capable of responding to the access request and determined by the scheduling center based on the access request of the user, downloading and caching video files from the video service node address determined by the scheduling center by the scheduling proxy server, splicing the cached video files into a complete media file by the scheduling proxy server, and responding to the access request of the user by the scheduling proxy server using cached complete media file.

The present disclosure also provides a scheduling proxy server for a CDN platform. The CDN platform may include at least one processor, and a memory communicably connected with the at least one processor for storing instructions executable by the at least one processor, wherein execution of the instructions by the at least one processor causes the at least one processor to: send a received access request of a user to a scheduling center, and receive a video service node address which is capable of responding to the access request and determined by the scheduling center based on the access request of the user, download and cache video files from the video service node address determined by the scheduling center, splice the cached video files into a complete media file, and respond to the access request of the user using cached complete media file.

The present disclosure further provides a non-transitory computer-readable medium. The non-transitory computer-readable medium may store executable instructions for a CDN platform. The executable instructions, when executed by a processor, cause the processor to: send a received access request of a user to a scheduling center by a scheduling proxy server, and receive a video service node address which is capable of responding to the access request and determined by the scheduling center based on the access request of the user, download and cache video files from the video service node address determined by the scheduling center by the scheduling proxy server, splice cached video files into a complete media file by the scheduling proxy server, and respond to the access request of the user by the scheduling proxy server using cached complete media file.

It should be understood that both the foregoing general description and the following detailed description are exemplary and explanatory only and are not restrictive of the disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

In order to more clearly illustrate the embodiments of the present disclosure, figures to be used in the embodiments will be briefly introduced in the following. Apparently, figures in the following description are some embodiments of the present disclosure, and other figures can be obtained by those skilled in the art based on these figures without inventive efforts.

FIG. 1 is a flow chart of a content delivery method for a CDN platform according to an embodiment of the present disclosure;

FIG. 2 is a schematic drawing of a scheduling proxy server for a CDN platform according to an embodiment of the present disclosure;

FIG. 3a is a schematic drawing of an embodiment of a content delivery system of the present disclosure;

FIG. 3b is a schematic drawing of another embodiment of a content delivery system of the present disclosure;

FIG. 4 is a schematic structural drawing of a computer system of an electronic device for applying the content delivery method for a CDN platform according to the embodiments of the present disclosure.

### DETAILED DESCRIPTION

In order to make the purpose, technical solutions, and advantages of the embodiments of the disclosure more clearly, technical solutions of the embodiments of the present disclosure will be described clearly and completely in conjunction with the figures. Obviously, the described embodiments are merely part of the embodiments of the present disclosure, but not all embodiments. Based on the embodiments of the present disclosure, other embodiments obtained by the ordinary skill in the art without inventive efforts are within the scope of the present disclosure.

The terminology used in the present disclosure is for the purpose of describing exemplary embodiments only and is not intended to limit the present disclosure. As used in the present disclosure and the appended claims, the singular forms “a,” “an” and “the” are intended to include the plural forms as well, unless the context clearly indicates otherwise. It shall also be understood that the terms “or” and “and/or” used herein are intended to signify and include any or all possible combinations of one or more of the associated listed items, unless the context clearly indicates otherwise.

It shall be understood that, although the terms “first,” “second,” “third,” etc. may include used herein to describe various information, the information should not be limited by these terms. These terms are only used to distinguish one category of information from another. For example, without departing from the scope of the present disclosure, first information may include termed as second information; and similarly, second information may also be termed as first information. As used herein, the term “if” may include understood to mean “when” or “upon” or “in response to” depending on the context.

Reference throughout this specification to “one embodiment,” “an embodiment,” “exemplary embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may include combined in any suitable manner.

It should be noted that, embodiments of the present application and the technical features involved therein may be combined with each other in case they are not conflict with each other.

An Http live streaming (HLS) transmission protocol plays an important role among transmission protocols used by major video websites. The HLS protocol is a streaming media transmission protocol realized by Apple Inc. based on the hyper text transport protocol (Http). The HLS protocol partitions continuous media data with huge capacity into numerous small files to transmit and meets the file transmission of a webpage server. By adopting a light index file that is continuously updated to control the download and play of the partitioned small media files, live broadcast and on-demand broadcast of stream media are realized. The HLS protocol supports automatic conversion of a code rate while prioritizing the smoothness, and is widely used by major video websites.

By the HLS protocol, after processing, video data are partitioned into media data ts files and media data index m3u8 files and are stored in a server. The m3u8 files are an organizational form of a file group. Video clips are organized together in a form of a play list to allow a multimedia player to download and play. The m3u8 files generally include a plurality of uniform resource locators (URL) of the above media data ts files. After obtaining the m3u8 files, the multimedia player downloads and plays the corresponding ts files based on the URL therein.

When a customer requests to access to certain video, the customer sends a request message to a scheduling center, and then the scheduling center responds with the address of a CDN node closest to the customer. Afterwards, a client accesses the corresponding CDN node with the closest distance based on the address fed back by the scheduling center so as to obtain a requested resource.

The inventor finds in a process of implementing the present disclosure that in certain accessing cases, when a plurality of advertisements exist in the video and are provided by different CDN nodes, the client needs to request for communication with a plurality of different nodes for many times. As a result, the communication between the client and the server (the scheduling center and CDN nodes) can be easily influenced by a network environment. As a result, response delay occurs, playing of the video is unsmooth and instable, and user experience is affected.

In order to reduce the times of communication between the user and a plurality of nodes and solve the problem of unsmooth and instable playing of the video caused by network response delay, the present disclosure provides a content delivery method for a CDN platform, a scheduling proxy server, a non-transitory computer-readable medium and a content delivery system.

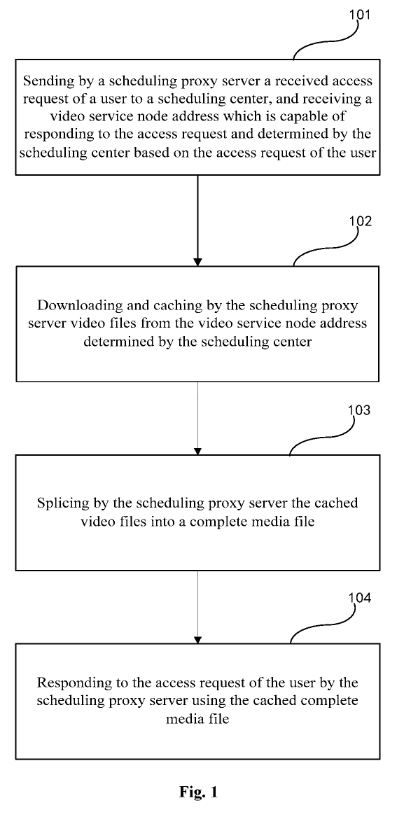

Referring to FIG. 1 which shows a content delivery method for a CDN platform according to one embodiment of the present disclosure, the method includes the following steps:

Step 101: sending by a scheduling proxy server a received access request of a user to a scheduling center, and receiving a video service node address which is capable of responding to the access request and determined by the scheduling center based on the access request of the user;

Step 102: downloading and caching by the scheduling proxy server video files from the video service node address determined by the scheduling center;

Step 103: splicing by the scheduling proxy server the cached video files into a complete media file; and

Step 104: responding to the access request of the user by the scheduling proxy server using the cached complete media file.

According to the embodiment of the present disclosure, a content access request of a user is received by the scheduling proxy server, and the video and advertisement responding to the access request of the user are obtained from the corresponding video service node based on the address of a video service node fed back by the scheduling center, and cached. The communication between the user and the video service node for many times is avoided. The user only needs to communicate with each video service node by the scheduling proxy server, then the cached media file is sent to the user by the scheduling proxy server, such that the communication among the scheduling center, the scheduling proxy server and the video service node as well as the downloading, caching and splicing of the video can be finished only in a corresponding local area network without easy influence from a network environment. Therefore, network delay is reduced and a response speed is improved.

Further, the scheduling proxy server receives a video service node address and an advertisement service node address which are capable of responding to the access request and determined by the scheduling center based on the access request of the user; the scheduling proxy server downloads and caches a video file and an advertisement file from the video service node address and the advertisement service node address determined by the scheduling center; the scheduling proxy server splices the cached video file and advertisement file into a complete media file; and the scheduling proxy server responds to the access request of the user using the cached complete media file.

The existing CDN platform contains a scheduling center, a plurality of video service nodes and a plurality of advertisement service nodes, and is used for providing different videos and different advertisements. Based on different access requests, the scheduling center can determine the video service node and advertisement service node which store corresponding resources.

Since the CDN platform contains a plurality of video service nodes and a plurality of advertisement service nodes, the addresses of the video service nodes are determined at least based on the distances between the user and all video service nodes capable of responding to the access request of the user, and the addresses of the advertisement service nodes are determined at least based on the distances between the user and all advertisement service nodes. But in a communication process, other factors are also considered. For example, a handling capacity, a response speed, the number of the access requests of users that are being processed, etc., of the video service nodes and the advertisement service nodes may be considered.

Preferably, the access request of the user is responded directly using the cached complete media file when the scheduling proxy server receives the access request of the user for the same video file, and the response speed is improved. In addition, since the video and advertisement are not required to be downloaded and cached from the corresponding video service nodes and advertisement service nodes by the scheduling proxy server any more, the work load of the video service nodes and advertisement service nodes is relieved.

Preferably, the downloading and caching by the scheduling proxy server a video file and an advertisement file from the video service node address and the advertisement service node address determined by the scheduling center includes: obtaining a corresponding video m3u8 file and a corresponding advertisement m3u8 file, downloading and caching ts video partitioned files from a corresponding video service node using the video m3u8 file, and downloading and caching ts advertisement partitioned files from a corresponding advertisement service node using the advertisement m3u8 file, by the scheduling proxy server based on the video service node address and the advertisement service node address.

Further, the scheduling proxy server splices the cached ts video partitioned files and ts advertisement partitioned files, caches the spliced media file and merges the video m3u8 file and the advertisement m3u8 file into a complete media m3u8 index file.

Further, the splicing by the scheduling proxy server the cached ts video partitioned files and ts advertisement partitioned files and caching the spliced media file by the scheduling proxy server includes: for example, for the existing ts video partitioned files A and B and a ts advertisement partitioned file a, analyzing head information zones of the ts video partitioned files A, B and the ts advertisement partitioned file a, and determining a file type (as MP4, a file playing duration (the summation of the playing durations of all partitioned durations), contained video and audio stream quantity (consistent to the quantity of all partitions), a coding standard adopted by each video and audio stream, and position and time information of all video and audio frames (key frames), contained in the ts video partitioned files A, B and the ts advertisement partitioned file a, in the whole media file to be spliced; and generating head information of the whole media file to be spliced based on a determining result.

Transition labels are added between a media data zone 1 of the ts video partitioned file A and a media data zone 2 of the ts advertisement partitioned file a and between the media data zone 2 of the ts advertisement partitioned file a and a media data zone 3 of the ts video partitioned file B for sequentially splicing; and the spliced media file is output and the media file is cached using the generated head information of the whole media file to be spliced and the media data of the whole media file to be spliced.

In the above embodiment, the ts video partitioned files A, B and the ts advertisement partitioned file adopt the same coding standard, so as to be consistent to the coding standard of the whole media file to be spliced. Further, the media data zones of the ts video partitioned files A, the ts advertisement partitioned files a and the ts video partitioned files B are spliced to the same media data zone in sequence, and form a legal media file.

According to the method of the embodiment of the present disclosure, the communication between the user and the video service node and the advertisement service node for many times is avoided. The user only needs to communicate with each video service node and advertisement service node by the scheduling proxy server, and then the media file is sent to the user by the scheduling proxy server, such that the communication between the scheduling center and the video service node and the advertisement service node can be finished only in a corresponding internal network without being easily influenced from a network environment. Therefore, network delay is reduced, a response speed is improved and user experience is further improved.

Besides, since the communication between the scheduling center and the video service node and the advertisement service node can be finished in a corresponding internal network, the probability of linking stealing is reduced consequently and protection for video and advertisement resources is realized.

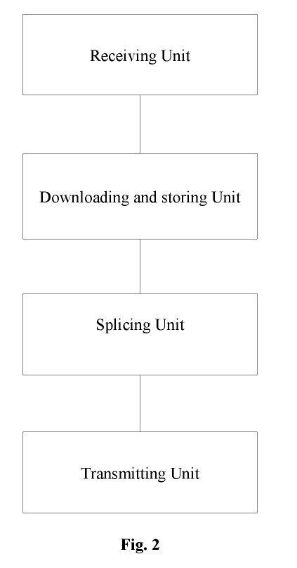

The method related to the embodiment as shown in FIG. 1 can be, referring to FIG. 2, executed by a scheduling proxy server according to the embodiments of the present disclosure.

A scheduling proxy server for a CDN platform includes:

a receiving unit, configured to send a received access request of a user to the scheduling center, and receive a video service node address which is capable of responding to the access request and determined by the scheduling center based on the access request of the user;

a downloading and storing unit, configured to download and cache video files from the video service node address determined by the scheduling center;

a splicing unit, configured to splice the cached video files into a complete media file; and

a transmitting unit, configured to respond to the access request of the user using the cached complete media file.

The scheduling proxy sever for a CDN platform in the present embodiment is one server or server cluster, wherein each unit/module may be a single server or server cluster, at this point, interaction between the units/modules is represented as the interaction between the servers or server clusters corresponding to the units/modules, and the plurality of servers or server clusters constitute the scheduling proxy server of the present disclosure together.

Specifically, the servers or server clusters constitute the scheduling proxy server of the present disclosure together includes:

a receiving server or server cluster, configured to send a received access request of a user to the scheduling center, and receive a video service node address which is capable of responding to the access request and determined by the scheduling center based on the access request of the user;

a downloading and storing server or server cluster, configured to download and cache video files from the video service node address determined by the scheduling center;

a splicing server or server cluster, configured to splice the cached video files into a complete media file; and

a transmitting server or server cluster, configured to respond to the access request of the user using the cached complete media file.

In one alternative embodiment, several units/modules in the units/modules constitute one server or server cluster together. For example, the receiving unit constitutes a first server or first server cluster, the downloading and storing and the splicing unit constitute a second first server or second server cluster together, and the transmitting unit constitutes a third server or third server cluster.

At this point, interaction between the units/modules is represented as the interaction between the first to third servers or the interaction between the first to third server clusters, and the first to third servers or the first to third server clusters constitute the scheduling proxy server of the present disclosure together.

Preferably, the above scheduling proxy server further includes:

an examining unit, configured to respond to the access request of the user directly using the cached complete media file when examining that the scheduling proxy server receives the access request of the user for the same video file.

The examining unit in the present embodiment may be a server or server cluster. At this point, interaction between the units is represented as the interaction between the servers or server clusters corresponding to the units, and the plurality of servers or server clusters constitute the scheduling proxy server of the present disclosure together.

In one alternative embodiment, several units in the units constitute a server or server cluster together.

Further, regarding the scheduling proxy server in the above embodiment, the receiving unit is configured to receive a video service node address and an advertisement service node address which are capable of responding to the access request and determined by the scheduling center based on the access request of the user; and

the downloading and storing unit is configured to obtain a corresponding video index file and a corresponding advertisement index file, download and cache video partitioned files from a corresponding video service node using the video index file, and download and cache advertisement partitioned files from a corresponding advertisement service node using the advertisement index file based on the video service node address and the advertisement service node address determined by the receiving unit.

The splicing unit is configured to splice the cached video partitioned files and advertisement partitioned files and cache the spliced media file; and merge the video index file and the advertisement index file into a complete media index file.

Further, the splicing unit is configured to analyze head information zones of the video partitioned files and the advertisement partitioned files, and determine a file type, a file playing duration, contained video and audio stream quantity, a coding standard adopted by each video and audio stream, and position and time information of all video and audio frames, contained in all video partitioned files and the advertisement partitioned files, in the whole media file to be spliced;

generate head information of the whole media file to be spliced based on a determining result;

sequentially splice using media data zones of all video partitioned files and all advertisement partitioned files, and generate media data of the whole media file to be spliced; and

output the spliced media file and cache the media file using the generated head information of the whole media file to be spliced and the media data of the whole media file to be spliced.

The embodiments of the present disclosure further provide a content delivery system, wherein the content includes videos and advertisements, and the system includes:

video service nodes;

advertisement service nodes;

a scheduling center, configured to determine the video service node and the advertisement service node which are capable of responding to the access request based on the access request of the user; and

the scheduling proxy server according to the above embodiments.

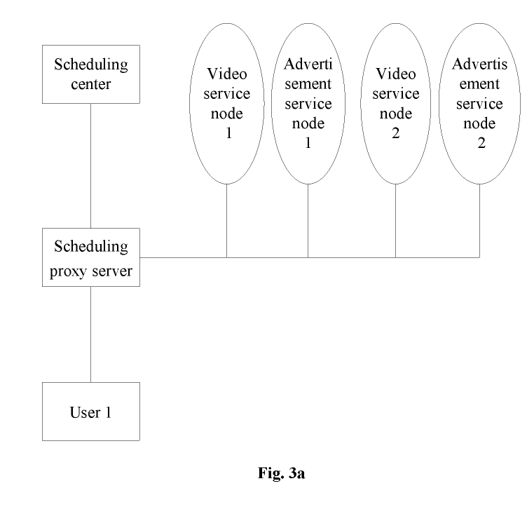

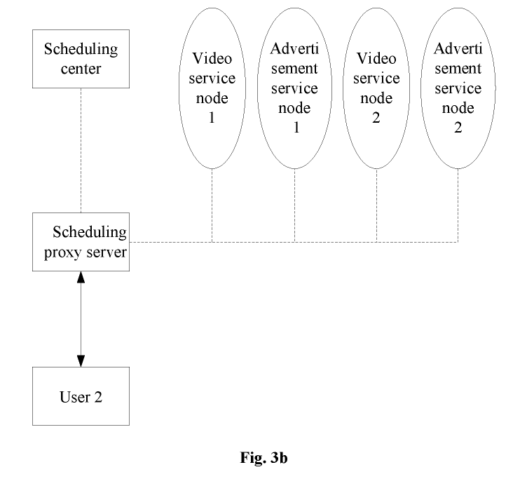

According to the content delivery system as shown in FIG. 3a, when receiving the access request of a user 1, the scheduling proxy server forwards the access request to the scheduling center. The scheduling center sends the addresses of a corresponding video service node and advertisement service node to the scheduling proxy server according to the access request. The scheduling proxy server obtains a corresponding video m3u8 file and a corresponding advertisement m3u8 file according to the received addresses of the video service node and advertisement service node, and merges the video m3u8 file and advertisement m3u8 file into a complete m3u8 index file. The scheduling proxy server downloads and caches ts video partitioned files from the corresponding video service node using the video m3u8 file, downloads and caches ts advertisement partitioned files from the corresponding advertisement service node using the advertisement m3u8 file, and further splices the cached video partitioned file and advertisement partitioned file and caches the spliced media file. Therefore, the scheduling proxy server responds to the access request of the user 1 using the cached complete media file.

According to the content delivery system as shown in FIG. 3b, the access request of a user 2 is responded directly using the cached complete media file when the scheduling proxy server receives the access request of the user 2 for the same video file.

Further, the present disclosure further provides a non-transitory computer readable storage medium, one or more programs including an executing instruction are stored in the storage medium, and the executing instruction is executable by an electronic device with a control interface to execute related steps in the above method embodiments, such as:

sending a received access request of a user to a scheduling center, and receiving a video service node address which is capable of responding to the access request and determined by the scheduling center based on the access request of the user;

downloading and caching video files from the video service node address determined by the scheduling center;

splicing the cached video files into a complete media file; and

responding to the access request of the user using the cached complete media file.

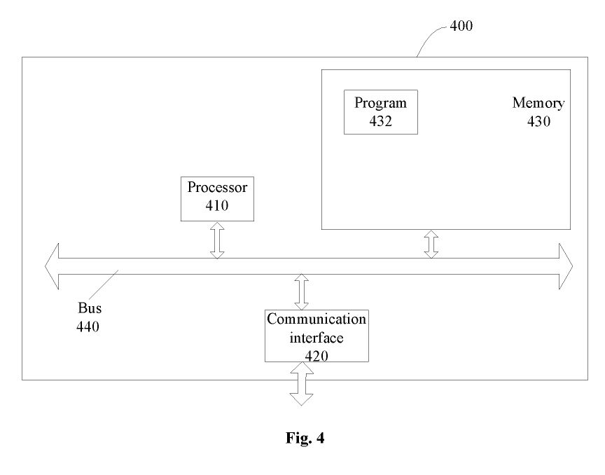

FIG. 4 shows a schematic structural drawing of a computer system of an electronic device for applying the content delivery method for a CDN platform according to the embodiments of the present disclosure, and the specific embodiments of the present disclosure do not limit specific implementation of the electronic device 400. As shown in FIG. 4, the electronic device 400 can includes:

a processor 410, a communication interface 420, a memory 430 and a communication bus 440, wherein

the processor 410, the communication interface 420 and the memory 430 finish communication with one another via the communication bus 440.

The communication interface 420 is configured to communicate with a network element such as a client end.

The processor 410 is configured to execute a program 432 in the memory 430 to execute the related steps in the above method embodiments.

Specifically, the program 432 may include a program code including a computer operation instruction.

The processor 410 is a central processing unit (CPU), or an application specific integrated circuit (ASIC), or configured to be one or more integrated circuits of the embodiments of the present application.

The memory 430 is configured to store the program 432. The memory may contain a high RAM memory, may also include a non-volatile memory, for example, at least one magnetic disk memory. The program 432 is specifically configured to enable the electronic device 400 to execute the following operations of:

a request receiving step: sending a received access request of a user to a scheduling center, and receiving a video service node address which is capable of responding to the access request and determined by the scheduling center based on the access request of the user;

a file downloading and caching step: downloading and caching video files from the video service node address determined by the scheduling center;

a file splicing step: splicing the cached video files into a complete media file; and

a file transmitting step: responding to the access request of the user using the cached complete media file.

Specific implementation of each step in program 432 can refer to corresponding description of corresponding steps and units in the above embodiments and are not repeated herein. Those skilled in the art can clearly know that for the purpose of convenient and compact description, a specific working process of the device and modules can refer to the corresponding process description in the aforesaid method embodiments, and is not repeated herein.

The present disclosure may further provide a non-transitory computer-readable medium. The non-transitory computer-readable medium may store executable instructions for a CDN platform. The executable instructions, when executed by a processor, cause the processor to: send by a scheduling proxy server a received access request of a user to a scheduling center, and receive a video service node address which is capable of responding to the access request and determined by the scheduling center based on the access request of the user, download and cache by scheduling proxy server video files from the video service node address determined by the scheduling center, splice by the scheduling proxy server the cached video files into a complete media file, and respond to the access request of the user by the scheduling proxy server using the cached complete media file.

The foregoing embodiments of device are merely illustrative, in which those units described as separate parts may or may not be separated physically. Displaying part may or may not be a physical unit, i.e., may locate in one place or distributed in several parts of a network. Some or all modules may be selected according to practical requirement to realize the purpose of the embodiments, and such embodiments can be understood and implemented by the skilled person in the art without inventive effort.

A person skilled in the art can clearly understand from the above description of embodiments that these embodiments can be implemented through software in conjunction with general-purpose hardware, or directly through hardware. Based on such understanding, the essence of foregoing technical solutions, or those features may be embodied as software product stored in computer-readable medium such as ROM/RAM, diskette, optical disc, etc., and including instructions for execution by a computer device (such as a personal computer, a server, or a network device) to implement methods described by foregoing embodiments or a part thereof.

The present disclosure may include dedicated hardware implementations such as application specific integrated circuits, programmable logic arrays and other hardware devices. The hardware implementations can be constructed to implement one or more of the methods described herein. Applications that may include the apparatus and systems of various examples can broadly include a variety of electronic and computing systems. One or more examples described herein may implement functions using two or more specific interconnected hardware modules or devices with related control and data signals that can be communicated between and through the modules, or as portions of an application-specific integrated circuit. Accordingly, the computing system disclosed may encompass software, firmware, and hardware implementations. The terms “module,” “sub-module,” “unit,” or “sub-unit” may include memory (shared, dedicated, or group) that stores code or instructions that can be executed by one or more processors.

Finally, it should be noted that, the above embodiments are merely provided for describing the technical solutions of the present disclosure, but not intended as a limitation. Although the present disclosure has been described in detail with reference to the embodiments, those skilled in the art will appreciate that the technical solutions described in the foregoing various embodiments can still be modified, or some technical features therein can be equivalently replaced. Such modifications or replacements do not make the essence of corresponding technical solutions depart from the spirit and scope of technical solutions embodiments of the present disclosure.

What is claimed is:

1. A content delivery method for a content delivery network (CDN) platform, comprising:
sending a received access request of a user to a scheduling center by a scheduling proxy server, and receiving a video service node address which is capable of responding to the access request and determined by the scheduling center based on the access request of the user;
downloading and caching video files from the video service node address determined by the scheduling center by the scheduling proxy server;
splicing the cached video files into a complete media file by the scheduling proxy server; and
responding to the access request of the user by the scheduling proxy server using cached complete media file.

2. The method according to claim 1, further comprising:
receiving a video service node address and an advertisement service node address which are capable of responding to the access request and determined by the scheduling center by the scheduling proxy server based on the access request of the user;
downloading and caching the video files and advertisement files from the video service node address and the advertisement service node address determined by the scheduling center by the scheduling proxy server;
splicing the cached video files and the advertisement files into a complete media file by the scheduling proxy server; and
responding to the access request of the user by the scheduling proxy server using the cached complete media file.

3. The method according to claim 1, further comprising:
responding to the access request of the user directly using the cached complete media file when the scheduling proxy server receives the access request of the user for the same video file.

4. The method according to claim 2, wherein:
downloading and caching video files and advertisement files from the video service node address and the advertisement service node address determined by the scheduling center by the scheduling proxy server further comprises:
obtaining a corresponding video index file and a corresponding advertisement index file, downloading and caching video partitioned files from a corresponding video service node using the video index file, and downloading and caching advertisement partitioned files from a corresponding advertisement service node using the advertisement index file, by the scheduling proxy server based on the video service node address and the advertisement service node address; and
splicing the cached video files and the advertisement files into the complete media file by the scheduling proxy server further comprises:
splicing the cached video partitioned files and advertisement partitioned files and caching the spliced media file by the scheduling proxy server by the scheduling proxy server, and
merging the video index file and the advertisement index file into a complete media index file.

5. The method according to claim 4, wherein splicing the cached video partitioned files and the advertisement partitioned files and caching the spliced media file by the scheduling proxy server by the scheduling proxy server further comprises:
analyzing head information zones of the video partitioned files and the advertisement partitioned files, and determining a file type, a file playing duration, contained video and audio stream quantity, a coding standard adopted by each video and audio stream, and position and time information of all video and audio frames, contained in all video partitioned files and the advertisement partitioned files, in the whole media file to be spliced;
generating head information of the whole media file to be spliced based on a determining result;
sequentially splicing using media data zones of all video partitioned files and all advertisement partitioned files, and generating media data of the whole media file to be spliced; and
outputting the spliced media file and caching the media file using the generated head information of the whole media file to be spliced and the media data of the whole media file to be spliced.

6. A scheduling proxy server for a CDN platform, comprising:
at least one processor; and
a memory communicably connected with the at least one processor for storing instructions executable by the at least one processor, wherein execution of the instructions by the at least one processor causes the at least one processor to:
send a received access request of a user to a scheduling center, and receive a video service node address which is capable of responding to the access request and determined by the scheduling center based on the access request of the user;
download and cache video files from the video service node address determined by the scheduling center;
splice the cached video files into a complete media file; and
respond to the access request of the user using cached complete media file.

7. The scheduling proxy server according to claim 6, wherein:
the execution of the instructions causes the at least one processor to send the received access request further cause the at least one processor to: receive a video service node address and an advertisement service node address which are capable of responding to the access request and determined by the scheduling center based on the access request of the user; and
the execution of the instructions causes the at least one processor to download and cache the video files further cause the at least one processor to: obtain a corresponding video index file and a corresponding advertisement index file, download and cache video partitioned files from a corresponding video service node using the video index file, and download and cache advertisement partitioned files from a corresponding advertisement service node using the advertisement index file based on the video service node address and the advertisement service node address.

8. The scheduling proxy server according to claim 6, wherein the execution of the instructions by the at least one processor further causes the at least one processor to:
respond to the access request of the user directly using the cached complete media file when examining that the scheduling proxy server receives the access request of the user for the same video file.

9. The scheduling proxy server according to claim 7, wherein the execution of the instructions causes the at least one processor to splice the cached the video files further cause the at least one processor to:
splice the cached video partitioned files and advertisement partitioned files and cache the spliced media file, and merge the video index file and the advertisement index file into a complete media index file.

10. The scheduling proxy server according to claim 9, wherein the execution of the instructions causes the at least one processor to splice the cached the video files further cause the at least one processor:
to analyze head information zones of the video partitioned files and the advertisement partitioned files, and determine a file type, a file playing duration, contained video and audio stream quantity, a coding standard adopted by each video and audio stream, and position and time information of all video and audio frames, contained in all video partitioned files and the advertisement partitioned files, in the whole media file to be spliced;
generate head information of the whole media file to be spliced based on a determining result;
sequentially splice using media data zones of all video partitioned files and all advertisement partitioned files, and generate media data of the whole media file to be spliced; and
output the spliced media file and cache the media file using the generated head information of the whole media file to be spliced and the media data of the whole media file to be spliced.

11. A non-transitory computer-readable storage medium storing executable instructions for a content delivery network (CDN) platform, wherein the executable instructions, when executed by a processor, cause the processor to:
send a received access request of a user to a scheduling center by a scheduling proxy server, and receive a video service node address which is capable of responding to the access request and determined by the scheduling center based on the access request of the user;
download and cache video files from the video service node address determined by the scheduling center by the scheduling proxy server;
splice cached video files into a complete media file by the scheduling proxy server; and
respond to the access request of the user by the scheduling proxy server using cached complete media file.

12. The non-transitory computer-readable storage medium according to claim 11, wherein the executable instructions, when executed by the processor, further cause the processor to:
receive a video service node address and an advertisement service node address which are capable of responding to the access request and determined by the scheduling center by the scheduling proxy server based on the access request of the user;
download and cache the video files and advertisement files from the video service node address and the advertisement service node address determined by the scheduling center by the scheduling proxy server;
splice the cached video files and the advertisement files into a complete media file by the scheduling proxy server; and
respond to the access request of the user by the scheduling proxy server using the cached complete media file.

13. The non-transitory computer-readable storage medium according to claim 11, wherein the executable instructions, when executed by the processor, further cause the processor to:
respond to the access request of the user directly using the cached complete media file when the scheduling proxy server receives the access request of the user for the same video file.

14. The non-transitory computer-readable storage medium according to claim 12, wherein:
the executable instructions to cause the processor to download and cache by the scheduling proxy server video files and the advertisement files from the video service node address and the advertisement service node address determined by the scheduling center further cause the processor to:
obtain a corresponding video index file and a corresponding advertisement index file, downloading and caching video partitioned files from a corresponding video service node using the video index file, and download and cache advertisement partitioned files from a corresponding advertisement service node using the advertisement index file, by the scheduling proxy server based on the video service node address and the advertisement service node address; and
the executable instructions to cause the processor to splice by the scheduling proxy server the cached video files and the advertisement files into the complete media file further cause the processor to:
splice the cached video partitioned files and advertisement partitioned files and caching spliced media file by the scheduling proxy server by the scheduling proxy server, and
merge the video index file and the advertisement index file into a complete media index file.

15. The non-transitory computer-readable storage medium according to claim 14, wherein the executable instructions to cause the processor to splice by the scheduling proxy server the cached video partitioned files and the advertisement partitioned files and cache the spliced media file by the scheduling proxy server further cause the processor to:
analyze head information zones of the video partitioned files and the advertisement partitioned files, and determining a file type, a file playing duration, contained video and audio stream quantity, a coding standard adopted by each video and audio stream, and position and time information of all video and audio frames, contained in all video partitioned files and the advertisement partitioned files, in the whole media file to be spliced;
generate head information of the whole media file to be spliced based on a determining result;
sequentially splice using media data zones of all video partitioned files and all advertisement partitioned files, and generating media data of the whole media file to be spliced; and
output the spliced media file and caching the media file using the generated head information of the whole media file to be spliced and the media data of the whole media file to be spliced.
